(19) United States
(12) Patent Application Publication
(10) Pub. No.: US 2026/0316225 A1
(43) Pub. Date: Oct. 15, 2026

(54) Multi-Use Pliers Tool

(71) Applicant: Line Cutterz, LLC, West Columbia, TX (US)

(72) Inventor: Vance P. Zahorski, Angleton, TX (US)

(73) Assignee: Line Cutterz, LLC, West Columbia, TX (US)

(21) Appl. No.: 19/643,680

(22) Filed: Apr. 9, 2026

Related U.S. Application Data
(60) Provisional application No. 63/786,275, filed on Apr. 9, 2025.

(51) Int. Cl. B25B 7/22

(52) U.S. Cl. CPC B25B 7/22

(57) ABSTRACT

A pliers tool includes first and second members mounted to each other for pivotal movement, each of the first and second members having a jaw at a front end and a handle extending to a rear end. The handle of the first member includes an upper edge and a lower edge. A blade is carried by the first member, has a lower edge, and is mounted for movement between a stored position and a deployed position. In the stored position, an entirety of the blade is within the handle of the first member, between the upper and lower edges of the handle of the first member. In the deployed position, the lower edge of the blade is outboard of the handle of the first member.

### CROSS-REFERENCE TO RELATED APPLICATIONS

This application claims the benefit of U.S. Provisional Application No. 63/786,275, filed Apr. 9, 2025, which is hereby incorporated by reference in its entirety.

### FIELD

The present invention relates generally to hand tools, and more particularly to pliers.

### BACKGROUND

Fishermen often carry a variety of tools when they fish. For example, a fisherman may have a tackle box or a vest filled with an assortment of flies, hooks, and other attachments for a fishing line. He might also carry a small guidebook detailing the creek, lake, or other body of water where he is fishing, along with recommendations on the best lure and line for specific fishing conditions. Additionally, fishermen typically bring multiple lines of varying weights to accommodate different fishing needs. In short, they carry a significant amount of gear. To avoid losing or forgetting any equipment, fishermen often store everything together, but this much gear can grow bulky and cumbersome.

Along with his other equipment, a fisherman usually carries at least one knife or snips and a pair of small pliers. These tools serve many purposes, both expected and unexpected, but are most often used for cutting and tying fishing line-whether to untangle it, tie it to a leader or tippet, remove a hook, or for other reasons. As a result, a fisherman frequently retrieves his knife, cuts the line, stows the knife, gets a set of pliers, attaches a fly, and puts his pliers away. This maneuver can grow tedious, and repetition can lead to complacency, increasing the risk of injury to himself or others. Moreover, if he needs to cut the line immediately, he may not have time to reach for his knife or snips. Worse yet, if he forgets these tools, he may be forced to rely on crude and ineffective methods, such as using his teeth or a rock, if cutting the line is even possible at all. There is a need for an improved solution.

### SUMMARY

In an embodiment, a pliers tool includes first and second members mounted to each other for pivotal movement, each of the first and second members having a jaw at a front end and a handle extending to a rear end. The handle of the first member includes an upper edge and a lower edge. A blade is carried by the first member, the blade having a lower edge and being mounted for movement between a stored position and a deployed position. In the stored position, an entirety of the blade is within the handle of the first member, between the upper and lower edges of the handle of the first member. In the deployed position, the lower edge of the blade is outboard of the handle of the first member.

In embodiments, in the deployed position, the lower edge of the blade is outboard of the lower edge of the handle. An arm is mounted for pivotal movement to the handle of the first member. The arm has a pivoted end and an opposed free end, and an upper edge and an opposed lower edge. The blade is carried in the arm between the pivoted end and the free end and between the upper and lower edges so that the lower edge of the blade is outboard of the lower edge of the arm. The arm further includes a ram projecting forward from the free end of the arm below the lower edge of the arm, thereby defining a gap between the lower edge of the arm and the ram, wherein the lower edge of the blade is exposed in the gap. The ram includes an upper edge, and the upper edge of the ram and the lower edge of the blade converge toward each other. In embodiments, the upper edge of the ram is arcuate and convex, and the lower edge of the blade is arcuate and convex. The ram includes an upper edge which is at least partially outboard of the lower edge of the handle of the first member when the arm is in the deployed position. A slot is formed through the arm, and a pin extends through the handle of the first member and is received in the slot to guide the pivotal movement of the arm between the stored and deployed positions. The slot is arcuate. In the first member, a niche is formed in the handle between the upper and lower edges of the handle, the niche is configured to receive the arm in the stored position thereof, and a foot projects inward into the niche. The foot is registered with a notch in the arm so as to receive the notch when the arm is in the stored position thereof.

In an embodiment, a pliers tool includes first and second members mounted to each other for pivotal movement, each of the first and second members having a jaw at a front end and a handle extending to a rear end. The handle of the first member includes an upper edge, a lower edge, and a niche within the handle bounded by the upper and lower edges. An arm is mounted to the handle of the first member for movement between a stored position and a deployed position. The arm carries a blade having a lower edge. In the stored position, an entirety of the blade is within the niche. In the deployed position, the lower edge of the blade is outboard of the handle.

In embodiments, the arm is mounted for pivotal movement. A window is formed in communication with the niche and interrupts the lower edge of the handle of the first member, wherein during movement of the arm between the stored and deployed positions, the blade moves through the window. In the stored position of the arm, the entirety of the blade is within the handle of the first member, between the upper and lower edges of the handle of the first member. In the deployed position of the arm, the lower edge of the blade is outboard of the handle of the first member. In the deployed position of the arm, the lower edge of the blade is outboard of the lower edge of the handle. The arm has a pivoted end, an opposed free end, an upper edge, an opposed lower edge, and a ram projecting forward from the free end of the arm below the lower edge of the arm, thereby defining a gap between the lower edge of the arm and the ram, wherein the lower edge of the blade is exposed in the gap. The ram includes an upper edge, and the upper edge of the ram and the lower edge of the blade converge toward each other. The upper edge of the ram is arcuate and convex, and the lower edge of the blade is arcuate and convex. The ram includes an upper edge which is at least partially outboard of the lower edge of the handle of the first member when the arm is in the deployed position. A slot is formed through the arm, and a pin extends through the handle of the first member and is received in the slot to guide the pivotal movement of the arm between the stored and deployed positions.

The above provides the reader with a brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIGS. 1 and 2 are left and right side perspective views of multi-use pliers sheathed in a cover;

FIGS. 3 and 4 are left and right side perspective views of the multi-use pliers of FIG. 1;

FIG. 5 is a perspective section view of the multi-use pliers taken along the line 5-5 in FIG. 3, showing the pliers closed and locked, and showing a blade stored in a stored position on a handle of the multi-use pliers;

FIG. 6 is an enlarged perspective section view of the multi-use pliers, showing the pliers closed but unlocked, and showing the blade now in a deployed position suitable for cutting fishing line; and FIG. 7 is a perspective section view of the multi-use pliers, showing the pliers unlocked and open, and showing the blade in the deployed position suitable for cutting fishing line.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

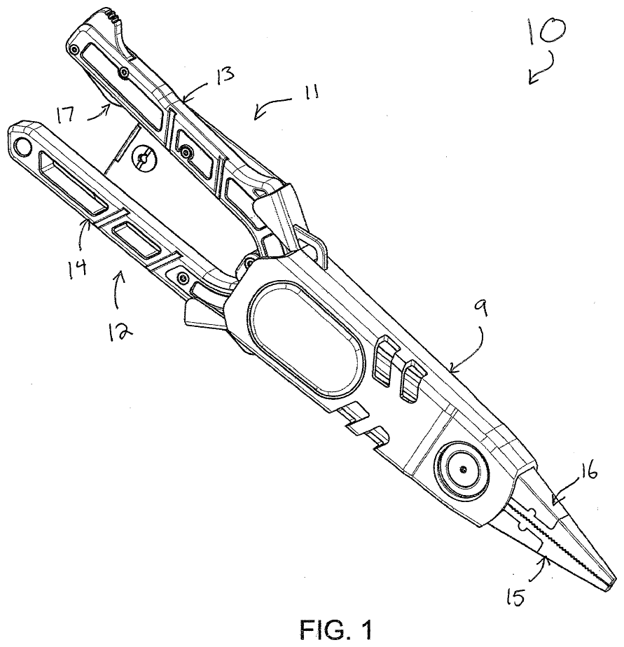

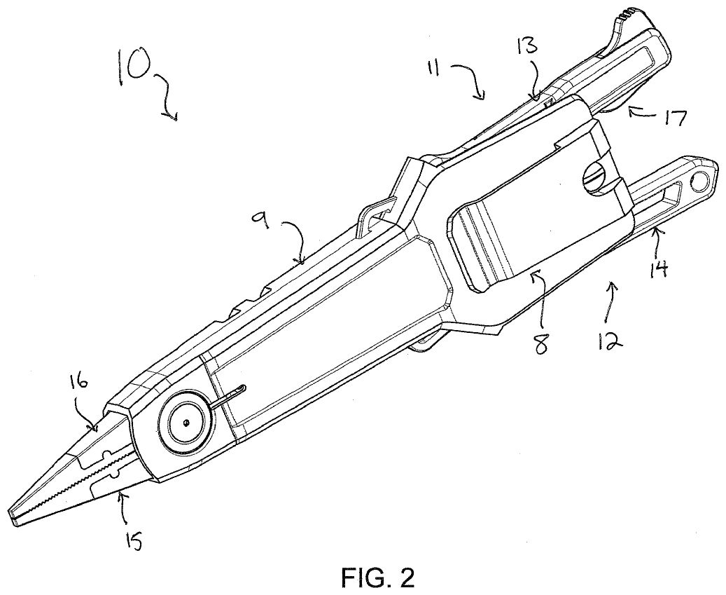

FIGS. 1 and 2 illustrate left and right perspective views of multi-use pliers tool 10 (hereinafter, “pliers 10”) sheathed in a case 9. The pliers 10 include two elongate members 11 and 12 pivoted to each other and defining a pair of opposed handles 13 and 14 at one end of the pliers 10 and a pair of opposed jaws 15 and 16 at another end of the pliers 10. The case 9 covers substantially all of the pliers 10 but for the ends of the handles 13 and 14 and the jaws 15 and 16. The case 9 retains the pliers 10 in a closed position and includes a clip 8 so that the case 9—and the pliers 10 therein—can be retained on a person's belt, pocket, vest, or other item.

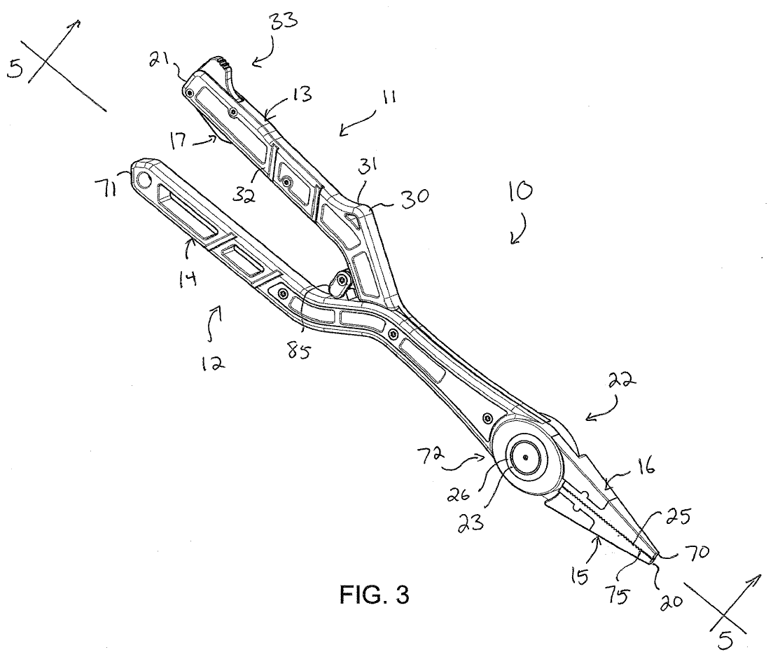

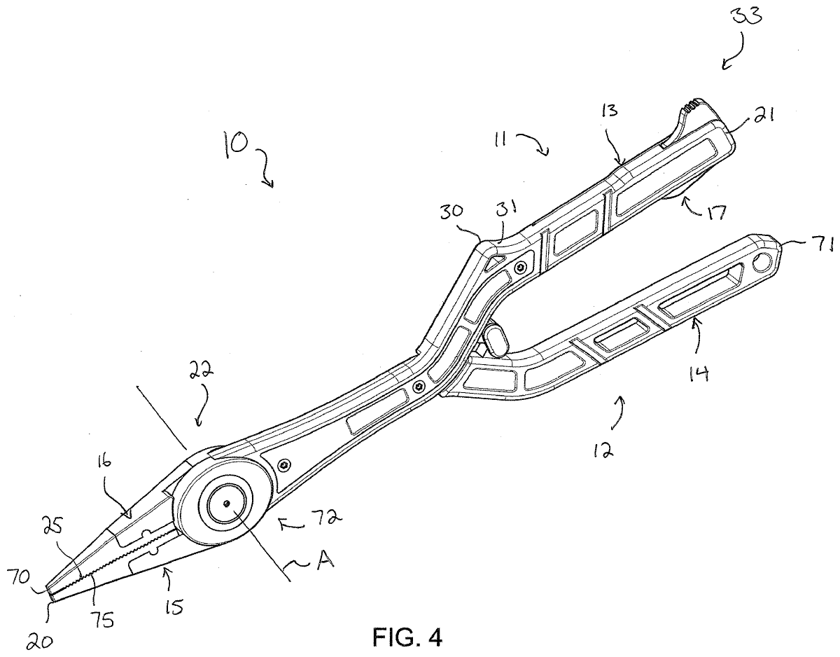

FIGS. 3 and 4 are also left and right perspective views of the pliers 10, but with the case 9 removed. Within the handle 13 is a concealed blade 17 suitable for cutting or slicing fishing line, rope, and other cordage and lines. The fisherman can grasp the members 11 and 12 and squeeze them together to open and close the jaws 15 and 16. The fisherman can also turn the tool around and deploy the blade 17 for cutting.

The first and second members 11 and 12 are pivoted to each other for movement. The first member 11 overlies the second member 12. In the orientations of the various drawings, the first member 11 has a handle 13 which is above the other handle 14 and a jaw 15 which is below the other jaw 16. This arrangement, however, is merely a function of how the drawings orient the pliers 10 and is not limiting. Indeed, the pliers 10 can be held with the handle 13 above the handle 14 or with the handle 14 held above the handle 13.

The first member 11 has a front end 20 and an opposed rear end 21. The jaw 15 is proximate the front end 20, and the handle 13 is proximate the rear end 21. The first member 11 is preferably constructed from a single, integral, monolithic piece of material, such as a molded, extruded, stamped, or otherwise formed piece of plastic or metal.

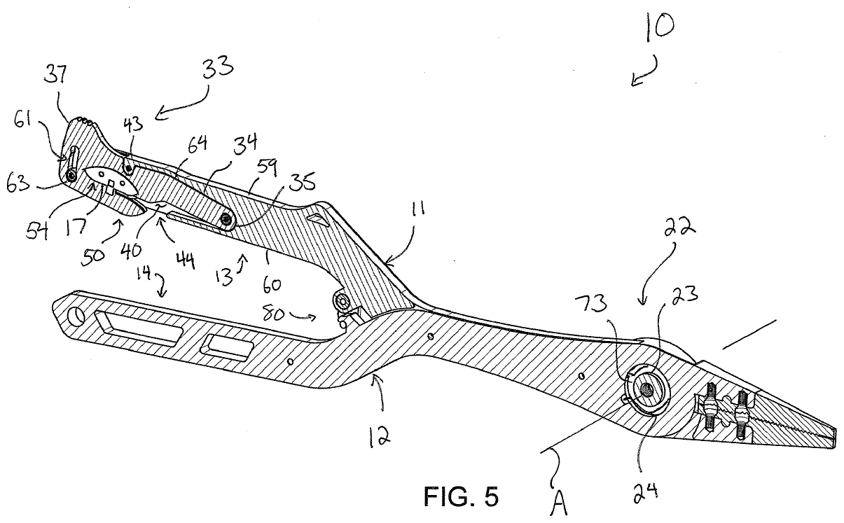

On the first member 11, between the handle 13 and the jaw 15, is a hub 22. The hub 22 has a wide cylindrical shape and a large annular bearing surface directed toward the second member 12. The hub 22 includes a central post 23 which projects laterally outward in a normal direction from the hub 22, as indicated by the line A in FIGS. 4 and 5. The post 23 operates as an axle and axis for pivotal movement of the first and second members 11 and 12. A torsional spring 24 (shown in FIGS. 5 and 7) carried in the hub 22 biases the first and second members 11 and 12 into an open position. Radially outside of the post 23 is a washer bushing 26 that acts as an additional bearing surface between the first and second members 11 and 12 during movement between that open position and a closed position.

In this embodiment, the jaw 15 of the first member 11 preferably has a needle-nose plier configuration. In other embodiments, the jaw 15 has a different configuration, such as a nipper, cutter, scissor, or other tool end. The jaw 15 tapers from a large proximal end proximate the hub 22 to a slender, pointed distal end at the front end 20. The jaw 15 has an inner surface 25 which is preferably smooth proximate the front end 20 and which is preferably ridged, ribbed, or formed with another texture between the smooth portion of the inner surface 25 and the hub 22.

The handle 13 of the first member 11 extends from the hub 22 opposite the jaw 15. The handle 13 is elongate, extending from the hub 22 to the rear end 21 of the member 11. It is quite long, especially compared with conventional pliers handler. A protrusion 30 projects upwardly from the handle 13. The protrusion 30 is proximate the hub 22 and is configured such that the fisherman can place his thumb against a gently sloping rear face 31 and apply pressure against the rear face 31 when using the pliers 10.

At the rear end 21 of the first member 11 is the blade 17. The blade 17 is carried on a larger blade assembly 33, as shown in the views of FIGS. 5 and 7, which are section views taken along the line 5-5 in FIG. 3. In this embodiment, the blade assembly 33 is contained and partially concealed between the main body of the handle 13 and a cover 32 screwed, riveted, or otherwise fixed onto the handle 13.

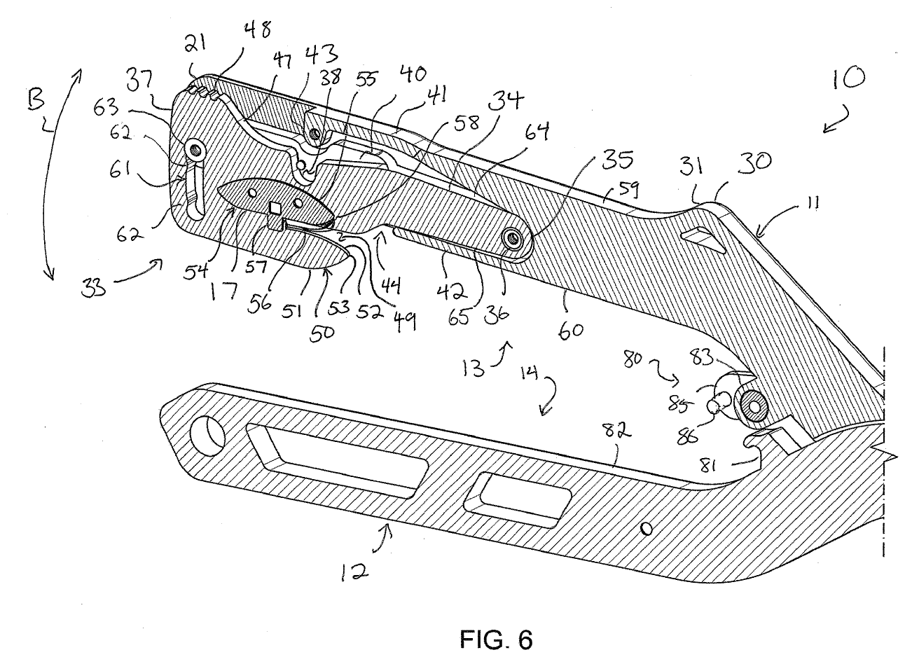

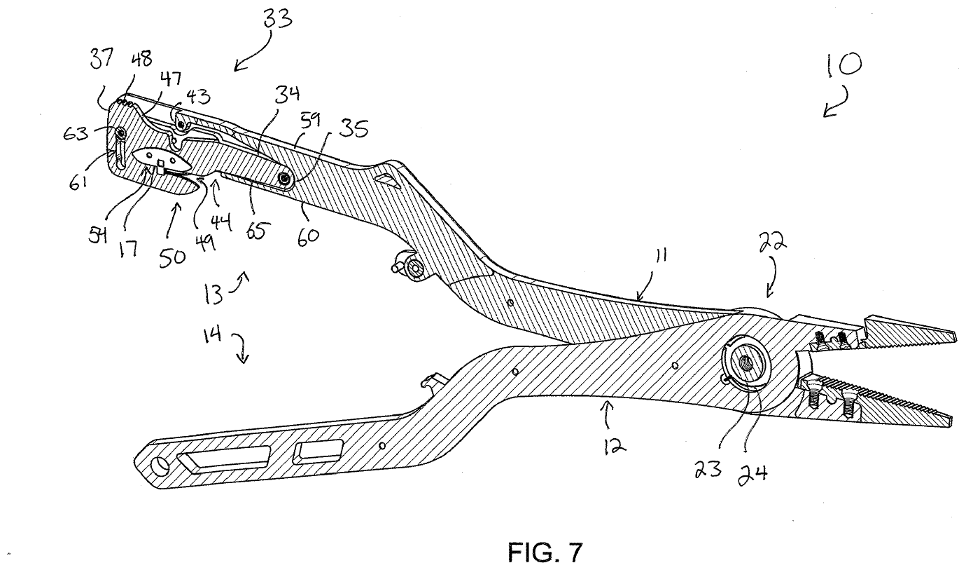

Turning now to FIGS. 5-7, the blade assembly 33 includes an arm 34 and the blade 17 carried on the arm 34. The arm 34 is preferably constructed from plastic or a material or combination of materials having material characteristics similar to plastic, and the blade 17 is preferably ceramic but in other embodiments is metal, plastic, or some other hard, strong, durable material which can be sharpened to an edge. The arm 34 has a pivoted end 35 which is mounted for pivotal movement to the handle 13 on a post 36. Opposite the pivoted end 35 is a free end 37 of the arm 34. The arm 34 swings in pivotal motion between a stored position (as shown in FIGS. 1-5) and a deployed position (as shown in FIGS. 6 and 7), as indicated by the arcuate double-arrowed line B in FIG. 6. Movement of the arm 34 between the stored and deployed positions moves the blade 17 between stored and deployed positions.

Each of the drawings shows the arm 34 in the stored position. In this stored position, the arm 34 sits within a niche or recess 40 in the body of the handle 13 and the blade 17 is encased within the handle 13. The niche 40 is a hollowed recess within the handle 13. An upper end of the niche 40 is defined by a slender upper wall 41 along the top edge of the handle 13. The lower end of the niche 40 is partially closed and partially open. Where it is closed, the body of the handle 13 narrows into a slender lower wall 42 along the bottom edge of the handle 13.

This slender lower wall 42 is short and does not extend toward the rear end 21 as far as the slender wall 41 does at the top edge of the handle 13. The slender lower wall 42 therefore terminates at a window 44, and the niche 40 is open along the window 44 all the way to the rear end 21 of the first member 11. The window 44 is formed in communication with the niche 40 and interrupts the lower edge of the handle 13.

The slender upper wall 41 extends rearwardly beyond the termination of the slender lower wall 42. At the rearward end of the slender upper wall 41, the slender upper wall 41 has a foot 43 that projects downward, into the niche 40. This foot 43 acts as a key for registering the arm 34 when it pivots. The arm 34 includes a notch 38 along its upper edge, and the notch 38 receives the foot 43 to register the arm with respect to the handle 13 when the arm 34 is in the stored position thereof. The lower slender wall 42 acts as a stop, limiting the extent of the swing of the arm 34 when it moves into the deployed position.

From the pivoted end 35, the arm 34 extends rearward and integrally to a rear portion 45. The rear portion 45 is partially visible when the arm 34 is in both the stored and deployed positions. The rear portion 45 includes a trigger 46 that projects above the handle 13. The trigger 46 has a slightly forward sloping front surface 47 and a knurled upper surface 48. When the fisherman desires to use the blade 17, the fisherman places his hand on either the front or upper surfaces 47 or 48 and pushes the trigger 46 downward, into the handle 13, to move the arm 34 from the stored position to the deployed position, along the arcuate arrowed line B, so that the blade 17 is accessible for cutting.

Opposite the trigger 46, the arm 34 includes a ram 50 projecting forwardly. The ram 50 has a lower edge 51, an upper edge 52, and a point 53 defined therebetween. The ram 50 is below a lower edge of the arm 34, defining a gap 49 between the lower edge of the arm 34 and upper edge 52 of the ram 50. In both the stored and deployed positions of the arm 34, the lower edge 51 is outside of the niche 40 and outside of the handle 13. In the stored position of the arm 34, the point 53 is just barely outside the niche 40 and the handle 13; the point 53 moves further outside of the niche 40 and handle 13 when the arm 34 is pivoted into the deployed position. The upper edge 52 starts at the point 53, outside the niche 40, and then arcuately and convexly curves upward to a hold 54 within the arm 34. The blade 17 is retained in the hold 54.

The blade 17 is held securely in the arm 34 at the hold 54. The blade 17 has a curved upper edge 55, which is dull, and an opposed curved lower edge 56, which is sharpened, preferably with a single chisel grind. The single chisel grind is extremely sharp and produces no drag on the fishing line when it is passed over the curved lower edge 56, because the line does not interact with and become caught on a flat portion of that edge 56.

A tab 57 on the bottom of the blade 17 is set into the top of the ram 50 to register the blade 17 in the hold 54, and two set pins extend laterally through the body of the blade 17 and engage with the body of the arm 34 to secure the blade 17 in place in the hold 54 of the arm 34.

The curved lower edge 56 of the blade 17 has a convex, arcuate shape. Proximate to a forward tip 58 of the blade 17, the curved lower edge 56 curves downwardly and convexly. The radius of the curved lower edge 56 increases as the lower edge 56 extends rearward toward the tab 57, and the curved lower edge 56 flattens toward the tab. At the tab 57, the curve of the lower edge 56 is level and flush with the upper edge 52 of the ram 50.

Similarly, the upper edge 52 of the ram 50 has a convex and arcuate shape. Proximate to the point 53 of the ram 50, the curved upper edge 52 curves upwardly and convexly. The radius of the curved upper edge 52 increases as that upper edge 52 extends rearwardly toward the free end 37 of the arm 34, and the curved upper edge 52 then flattens as it nears the lower edge 56 of the blade 17.

In other words, as the lower edge 56 of the blade 17 and the upper edge 52 of the ram 50 converge toward each other, they come into contact with each other in near parallel alignment. In yet other words, a normal line projecting outward from the curved lower edge 56 changes orientation from the tip 58 to the tab 57, from an orientation transverse to the ram 50 to an orientation perpendicular to the ram 50. In this way, the curved lower edge 56 ramps downward into contact with the ram 50, such that a fishing line which is pulled against the blade 17 will ride along the curved lower edge 56 or along the upper edge 52 of the ram 50 until it is either cut or pulled into the decreasing angle formed between the ram 50 and the curved lower edge 56, where the fishing line is eventually forced into contact with and against the curved lower edge 56. This shape effects a cutting action achieved by the simultaneous cutting and sliding of the line along the curved lower edge 56, which provides a smoother, cleaner cut than can be achieved by a straight-edged blade.

Of course, the fisherman can only cut fishing line against the blade when the arm 34 is in the deployed position. Still referring to FIGS. 5-7, the handle 13 of the pliers 10 has an upper edge 59 and an opposed lower edge 60. That lower edge 60 is directed toward the opposite handle 14 of the pliers 10. The lower edge 60 extends along most of the length of the member 11, from the hub 22, rearward along the handle 13, to the window 44 where the arm 34 moves into and out of the niche 40. The lower edge 60 defines an abutment surface: when the fisherman wants to cut a line and pull it against the blade 17, he can start by pulling it against and then along the lower edge 60 toward the blade 17, and the line will ride smoothly along the lower edge 60 until it is cut against the blade 17.

First, though, the fisherman moves the arm 34 into the deployed position. He does this by pushing downward on the front surface 47 or upper surface 48 of the trigger 46, so that the arm 34 pivots downward along the double-arrowed line B in FIG. 6. The fisherman must apply a sufficient amount of force to move the arm 34. The arm 34 includes a slot 61 formed therein, proximate to the free end 37. The slot 61 is oriented vertically in the arm 34, transverse to the length of the arm 34, and it is slightly arcuate between a top end and a bottom end. The slot 61 has a constant width between the top end and the bottom end but for two detents 62. The detents 62 are inward projections, extending into the slot 61 from the rear face thereof. One detent 62 is located just below the top end of the slot 61, and the other detent 62 is located just above the bottom end of the slot 61. The detents 62 reduce the width of the slot 61 to just less than the diameter of a pin 63 which is fit into the slot 61. In this embodiment, the detents 62 are inward projections, and in other embodiments, the detents 62 are sprung ball detents, magnetic retention mechanisms, or other mechanisms or structures.

The pin 63 extends from the handle 13. It is preferably mounted to extend transversely from the handle 13 to the cover 32 secured to the handle 13. The pin 63 can move through the slot 61 between the top and bottom ends. However, some force is required to move the pin 63 past the detents 62 at the top and the bottom ends. Force is required to move the pin 63 upwards, past the upper detent 62 and into the top end, and force is required to move the pin 63 downwards, past the lower detent 62 and into the bottom end. Such movement locks the pin 63 in the top or bottom ends. To move the pin 63 out of the top or bottom ends, the fisherman must apply a similar amount of force to move the pin 63 upwards, past the lower detent 62 and out of the bottom end, and also to move the pin 63 downward, past the upper detent 62 and out of the top end, so that the pin 63 can be moved to the opposite end of the slot 61.

Interaction of the pin 63 in the slot 61 guides and limits the pivotal movement of the arm 34 with respect to the handle 13. The arm 34 has opposed upper and lower edges 64 and 65. When the arm 34 is in the stored position, as in FIG. 5, the upper edge 64 of the arm 34 is against the slender upper wall 41 of the handle 13, and the lower edge 65 of the arm 34 is away from the slender lower wall 42 of the handle 13. The lower edge 65 of the arm 34 is preferably entirely within the niche 40. The blade 17 is also preferably entirely within the niche 40, and thus the entirety of the blade 17 is preferably within the handle 13 between the upper and lower edges 59 and 60 thereof. The ram 50 is partially within the niche 40 and partially outside the niche 40. The pin 63 is locked into the bottom end of the slot 61, preventing accidental or inadvertent movement of the arm 34 out of the stored position.

When the fisherman desires to use the blade 17 to cut fishing line, he moves the arm 34 downward, again by pushing down on the trigger 46. With sufficient applied force, the pin 63 moves out of the bottom end of the slot 61, past the lower detent 62, and up to the top end of the slot 61 where it locks on the other side of the lower detent 62. In this position, the upper edge 64 of the arm 34 is away from the slender upper wall 41 of the handle 13, and the lower edge 65 of the arm 34 is against the slender lower wall 42 of the handle 13. A forward portion of the lower edge 65 of the arm 34 is within the niche 40, but the lower edge 65 is curved and bends out of the niche 40 when the arm 34 is in the deployed position, as shown in FIGS. 6 and 7.

When the arm 34 is in the stored position, the lower edge 60 of the handle 13 is uninterrupted by the blade 17. The ram 50 interrupts the lower edge 60, however. The point 53 of the ram 50 is just slightly below the lower edge 60, such that a small portion of the upper edge 52 is at least partially outboard of the lower edge 60 of the handle 13 and visible below the lower edge 60, extending from the point 53 to within the niche 40. The entirety of the lower edge 51 of the ram 50 is exposed and visible when the arm 34 is in the stored position. When the arm 34 is moved into the deployed position, the blade 17 is outboard of the lower edge 60 of the handle 13, and the lower edge 60 of the handle 13 is interrupted by the blade 17 and by the lower edge 65 of the arm 34. The rear portion of the lower edge 65 bends and extends out through the window 44, interrupting the lower edge 60. That lower edge 65 leads toward the lower edge 56 of the blade 17, so that a line which the fisherman draws across the lower edge 60 of the handle 13 will ride along the lower edge 60 of the arm 34 and will then ride along the lower edge 56 of the blade 17, eventually cutting against the blade 17. Thus, when the arm 34 is moved into the deployed position, the fishing line is guided from one interruption edge to another until it is eventually cut by the blade 17.

The foregoing discussion has been made only with respect to the first member 11. The first member 11 preferably carries the blade 17, but in other embodiments, the second member 12 holds the blade 17 instead of or in addition to the first member 11. These drawings, however, show an embodiment in which a blade 17 is located only in the first member 11, not the second member 12, and so description of the second member 12 is made with respect to an embodiment that does not include a blade 17.

The second member 12 has, as shown in the orientation of these drawings, a handle 14 which is below the other handle 13 and a jaw 16 which is above the other jaw 15. The second member 12 has a front end 70 and an opposed rear end 71. The jaw 16 is proximate the front end 70 and the handle 14 is proximate the rear end 71. The second member 12 is preferably constructed from a single, integral, monolithic piece of material, such as a molded, extruded, stamped, or otherwise formed piece of plastic or metal.

On the second member 12, between the handle 14 and the jaw 16, is a hub 72. The hub 72 has a wide cylindrical shape and a large annular bearing surface directed toward the hub 22 of the first member 11. The hub 72 includes a central socket 73 which securely receives the post 23 of the hub 22. When so assembled, the post 23 and socket 73 operate as the axis for rotational movement between the first and second members 11 and 12.

In this embodiment, the jaw 16 of the second member 12 preferably has a needle-nose plier configuration. In other embodiments, the jaw 16 has a different configuration, such as a nipper, cutter, scissor, or other tool end. The jaw 16 tapers from a large proximal end proximate the hub 72 to a slender, pointed distal end at the front end 70. The jaw 16 has an inner surface 75 which is preferably smooth proximate the front end 70 and which is preferably ridged, ribbed, or formed with another texture between the smooth portion of the inner surface and the hub 72.

The handle 14 of the second member 12 extends from the hub 72 opposite the jaw 16. The handle 14 is elongate, extending from the hub 72 to the rear end 71 of the member 12. It is quite long, especially compared with conventional pliers handles.

There is a locking mechanism 80 carried between the two members 11 and 12. Referring primarily to FIG. 6, the locking mechanism 80 includes a catch 81 formed on an upper edge 82 of the second member 12 that projects upwardly. The catch 81 is open in the rearward direction. A post 83 is opposite the catch 81, mounted on and projecting downwardly from the lower edge 60 of the first member 11. The post 83 carries a latch 84 mounted for rotational movement on the end of the post 83. The latch 84 includes a plate 85 with a preferably oval shape and a peg 86 projecting laterally outward from the free end of the plate 85. The latch 84 can rotate or pivot between a locked and unlocked position.

FIGS. 1-6 illustrate the latch 84 in the locked position. The plate 85 is swung down and the peg 86 is engaged under the catch 81. When the fisherman desires to use the pliers 10, he lifts the latch 84, unhooking the peg 86 from the catch 81 and rotating the plate 85 upward so that the peg 86 is clear of the catch 81. This places the locking mechanism 80 in the unlocked position, so that the fisherman can now use the pliers 10.

In operation, the fisherman picks up the pliers 10 by hand, grasping the members 11 and 12 at the handles 13 and 14. The pliers 10 are held between the fisherman's palm and his fingers, in either his left or right hand.

When the pliers 10 are open, the handles 13 and 14 are apart from each other and the jaws 15 and 16 are apart from each other. The torsional spring 24 biases the pliers 10 into the open position. The fisherman moves the pliers 10 into a closed position by squeezing his fingers into his palm to close the handles 13 and 14 toward each other. The fisherman can thus use the pliers 10 to tightly grasp something between the jaws 15 and 16. Preferably, when the pliers 10 are closed, the jaws 15 and 16 are completely closed but the handles 13 and 14 maintain a gap therebetween, thereby allowing the fisherman to exert a large amount of force on the handles 13 and 14. Moreover, when the handles 13 and 14 are closed, the blade 17 is still spaced apart from the other handle 14 so as not to contact or be impacted by it.

When the fisherman desires to cut a filament such as fishing line, he turns the pliers 10 around in his hand. depresses the trigger 46 to push the arm 34 into the deployed position. The fisherman then grabs the fishing line with his free hand and forms a loop with the line holding two portions of the line together to form a loop extending outward from his hand. He feeds the loop between the handles 13 and 14, moving generally from the hub 22 to the rear end 21 of the first member 11. He then pulls the loop backward, such that the fishing line is pulled either along the lower edge 60 of the handle at the lower slender wall 42 of the body of the handle 13 or along the upper edge 52 of the ram 50, such that the line is drawn into the gap 49 between the upper edge 52 of the ram 50 and the lower edge 56 of the blade 17. The lower edge 56 of the blade 17 is exposed in the gap 49. As the fishing line is pulled backward into the increasingly-smaller gap 49, the line is forced against the lower edge 56 and is sliced. With the line now cut, the fisherman pushes the arm 34 back into its stored position, moves the locking mechanism 80 into the locked position, and returns the pliers 10 to their storage place.

Alternatively, the fisherman can leave the pliers 10 in the cover 9 or on his belt clip, and the blade 17 is still accessible. The blade 17 is located proximate the rear end 21 of the member 11, and when the pliers 10 are sheathed in the case 9, the blade 17 is above the case 9, still accessible to be used by the fisherman without removing the pliers 10 from the case 9. The fisherman can thus slide the fishing line through the pliers 10 to cut the line without having to remove the pliers 10. This allows for quick, efficient, one-handed operation.

A preferred embodiment: is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. A pliers tool comprising:
first and second members mounted to each other for pivotal movement, each of the first and second members having a jaw at a front end and a handle extending to a rear end;
the handle of the first member including an upper edge and a lower edge;
a blade carried by the first member, the blade having a lower edge and being mounted for movement between a stored position and a deployed position;
in the stored position, an entirety of the blade is within the handle of the first member, between the upper and lower edges of the handle of the first member; and
in the deployed position, the lower edge of the blade is outboard of the handle of the first member.

2. The pliers tool of claim 1, wherein in the deployed position, the lower edge of the blade is outboard of the lower edge of the handle.

3. The pliers tool of claim 1, further comprising:
an arm mounted for pivotal movement to the handle of the first member;
the arm has a pivoted end and an opposed free end, and an upper edge and an opposed lower edge; and
the blade is carried in the arm between the pivoted end and the free end and between the upper and lower edges so that the lower edge of the blade is outboard of the lower edge of the arm.

4. The pliers tool of claim 3, wherein the arm further comprises a ram projecting forward from the free end of the arm below the lower edge of the arm, thereby defining a gap between the lower edge of the arm and the ram, wherein the lower edge of the blade is exposed in the gap.

5. The pliers tool of claim 4, wherein:
the ram includes an upper edge; and
the upper edge of the ram and the lower edge of the blade converge toward each other.

6. The pliers tool of claim 5, wherein:
the upper edge of the ram is arcuate and convex; and
the lower edge of the blade is arcuate and convex.

7. The pliers tool of claim 5, wherein the ram includes an upper edge which is at least partially outboard of the lower edge of the handle of the first member when the arm is in the deployed position.

8. The pliers tool of claim 3, further comprising a slot formed through the arm, and a pin extending through the handle of the first member and received in the slot to guide the pivotal movement of the arm between the stored and deployed positions.

9. The pliers tool of claim 8, further comprising a case sheathing the pliers, wherein the blade is accessible when the pliers are sheathed in the case.

10. The pliers tool of claim 3, further comprising, in the first member:
a niche formed in the handle between the upper and lower edges of the handle, the niche configured to receive the arm in the stored position thereof; and
a foot projecting inward into the niche, the foot registered with a notch in the arm so as to receive the notch when the arm is in the stored position thereof.

11. A pliers tool comprising:
first and second members mounted to each other for pivotal movement, each of the first and second members having a jaw at a front end and a handle extending to a rear end;
the handle of the first member including an upper edge, a lower edge, and a niche within the handle bounded by the upper and lower edges;
an arm mounted to the handle of the first member for movement between a stored position and a deployed position, the arm carrying a blade having a lower edge;
in the stored position, an entirety of the blade is within the niche; and
in the deployed position, the lower edge of the blade is outboard of the handle.

12. The pliers tool of claim 11, wherein the arm is mounted for pivotal movement.

13. The pliers tool of claim 11, further comprising a window formed in communication with the niche and interrupting the lower edge of the handle of the first member, wherein during movement of the arm between the stored and deployed positions, the blade moves through the window.

14. The pliers tool of claim 11, wherein:
in the stored position of the arm, the entirety of the blade is within the handle of the first member, between the upper and lower edges of the handle of the first member; and
in the deployed position of the arm, the lower edge of the blade is outboard of the handle of the first member.

15. The pliers tool of claim 11, wherein in the deployed position of the arm, the lower edge of the blade is outboard of the lower edge of the handle.

16. The pliers tool of claim 11, wherein the arm has a pivoted end, an opposed free end, an upper edge, an opposed lower edge, and a ram projecting forward from the free end of the arm below the lower edge of the arm, thereby defining a gap between the lower edge of the arm and the ram, wherein the lower edge of the blade is exposed in the gap.

17. The pliers tool of claim 16, wherein:
the ram includes an upper edge; and
the upper edge of the ram and the lower edge of the blade converge toward each other.

18. The pliers tool of claim 17, wherein:
the upper edge of the ram is arcuate and convex; and
the lower edge of the blade is arcuate and convex.

19. The pliers tool of claim 16, wherein the ram includes an upper edge which is at least partially outboard of the lower edge of the handle of the first member when the arm is in the deployed position.

20. The pliers tool of claim 16, further comprising a slot formed through the arm, and a pin extending through the handle of the first member and received in the slot to guide the pivotal movement of the arm between the stored and deployed positions.
